(19) United States
(12) Patent Application Publication
(10) Pub. No.: US 2007/0279495 A1
(43) Pub. Date: Dec. 6, 2007

(54) Robust Wireless High-Speed Data Services Across An HFC Infrastructure Using Wired Diversity Techniques

(75) Inventor: Robert L. Howald, Orlando, FL (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: GENERAL INSTRUMENT CORPORATION, Horsham, PA (US)

(21) Appl. No.: 11/736,946

(22) Filed: Apr. 18, 2007

Related U.S. Application Data
(60) Provisional application No. 60/793,693, filed on Apr. 20, 2006.

(51) Int. Cl. H04N 17/00

(52) U.S. Cl. 348/193

(57) ABSTRACT

A system and method are provided for performing wireless diversity processing in a data-over-cable network. A diversity controller is provided which, based on signal-to-noise ratio, chooses an optimal path for receiving and transmitting data to and from a subscriber location. A stand-mounted access point enables wireless communication with subscriber locations. Diversity processing includes selection diversity, maximal rate combining, and equal gain combining.

### CROSS REFERENCE TO RELATED APPLICATIONS

This application claims the benefit of U.S. Provisional Application Ser. No. 60/793,693 filed on Apr. 20, 2006, entitled “Robust Wireless High-Speed Data Services Across An HFC Infrastructure Using Wired Diversity Techniques,” which is incorporated herein by reference in its entirety.

### FIELD OF THE INVENTION

This disclosure relates generally to cable modem systems, and more particularly to a system and method using antenna diversity and combining techniques in a data over cable network.

### BACKGROUND OF THE INVENTION

Cable modems are frequently used to connect personal computers to the Internet and other networks. One attraction to cable modems is the high speed connectivity they provide. In practice, cable network operators typically implement the Data-Over-Cable Interface Specification (DOCSIS), which is a known standard defining the communication requirements for a data-over-cable system.

Cable network operators have also begun taking advantage of wireless technology to provide data access to consumers and businesses. In the wireless case, the physical infrastructure required includes a wireless access point that provides a data connection between the cable plant, which includes cable operator's equipment used to provide communication, and subscriber devices that sit on the outside of homes (of cable customers) and buildings that are within the range of the wireless access point. Typically, cable operators place wireless routers and/or antennas including converter equipment on existing utility poles in an area/neighborhood in order to transmit wireless signals to the homes and businesses within a given range.

While the use of wireless technology to provide data access substantially eliminates the infrastructure issues associated with hard wiring homes and businesses, the wireless channel often adds unknown impairment characteristics that DOCSIS was not designed to support. For example, wideband signals are more likely to be impacted by frequency selective fading. Also, the performance of DOCSIS is of particular concern for systems operated in the unlicensed frequency bands because these regions are more prone to co-channel interference by other entities who share the frequency band.

In traditional wireless communication systems, wireless diversity techniques are used to overcome the affects of fading and other performance issues. For example, techniques such as selection diversity and maximum ratio combining are used to prevent degradation in system performance. For a practical DOSCIS or similarly capable, high performance data system implemented via a wireless data-over-cable network, the best performing systems and ultimately most successful services will provide feasible solutions to such problems to ensure that the combined wired plus wireless network meets or exceeds well-understood end user expectations for broadband service.

### SUMMARY OF THE INVENTION

Accordingly, the present invention relates to a system and method for preventing degradation in operating performance due to problems, such as fading, in a DOCSIS based HFC/wireless network. Specifically, the invention relates to a system and method for performing antenna diversity processing in a DOCSIS based HFC/wireless network. In one embodiment, the system and method performs diversity processing techniques to overcome the effects of multipath fading. These techniques may include, for example but not limited to, selection diversity, maximal ratio combining, and/or other diversity techniques.

In one embodiment, a cable network headend of the present invention comprises a cable modem termination system (CMTS) and a diversity controller. The diversity controller is configured to receive signals from a plurality of antennas spatially separated in the cable network and process the plurality of signals to reduce the effects of multipath fading. The diversity controller may also be configured to determine a signal-to-noise (SNR) ratio associated with each of the received data signals and to obtain an optimal signal based on the SNR associated with each of the received data signals prior to processing the signal using traditional DOCSIS CMTS processing. In determining whether a signal is optimal, an administrator may consider factors such as cost and performance.

A method of processing data signals in a cable data network utilizing the foregoing system may comprise the steps of: receiving a plurality of data signals from a plurality of antennas located at separate locations in the cable data network, determining a signal-to-noise (SNR) ratio associated with each of the received data signals and obtaining an optimal signal based on the SNR associated with each of the received data signals. In one embodiment, the optimal signal may be the one of the plurality of data signals having the highest SNR. In another embodiment, the optimal signal may be obtained by scaling each signal in parallel by a scaling factor which takes into consideration the SNR of each signal. The scaled signals may then be combined to achieve an optimal signal. Once the optimal signal has been obtained, this diversity controller may select the link providing the optimal signal to ensure a better probability of reception. That is, the controller can select either the transmission path from a particular antenna or from a combination of antennas that yields the desired reception characteristics.

Accordingly, the system and method of the present invention enables cable operators to improve performance, mitigate channel issues, and enable enhanced link connectivity while exploiting the benefits of the high-quality channel provided by the HFC channel.

### BRIEF DESCRIPTION OF THE DRAWINGS

FIG. 1 depicts a DOCSIS based wireless network, in accordance with one embodiment of the invention.

FIG. 2 is a high-level flowchart depicting an overall process for selecting an optimal signal, in accordance with one embodiment of the invention.

### DETAILED DESCRIPTION OF THE INVENTION

A system and method are provided for using diversity processing to process signals in a DOCSIS based wireless network. In one embodiment, the system and method performs diversity processing techniques to overcome the effects of multipath fading. These techniques may include, for example but not limited to, selection diversity, maximal ratio combining, and/or other diversity techniques. Implementing these techniques via a cable network allows the technique to take advantage of the inherent distributed aspect of a cable system. Incorporating diversity processing augments the cable system with wireless access points conveniently and without intrusion into the traditional cable infrastructure design. Path length differences from multiple access points in the cable network are absorbed in the processing.

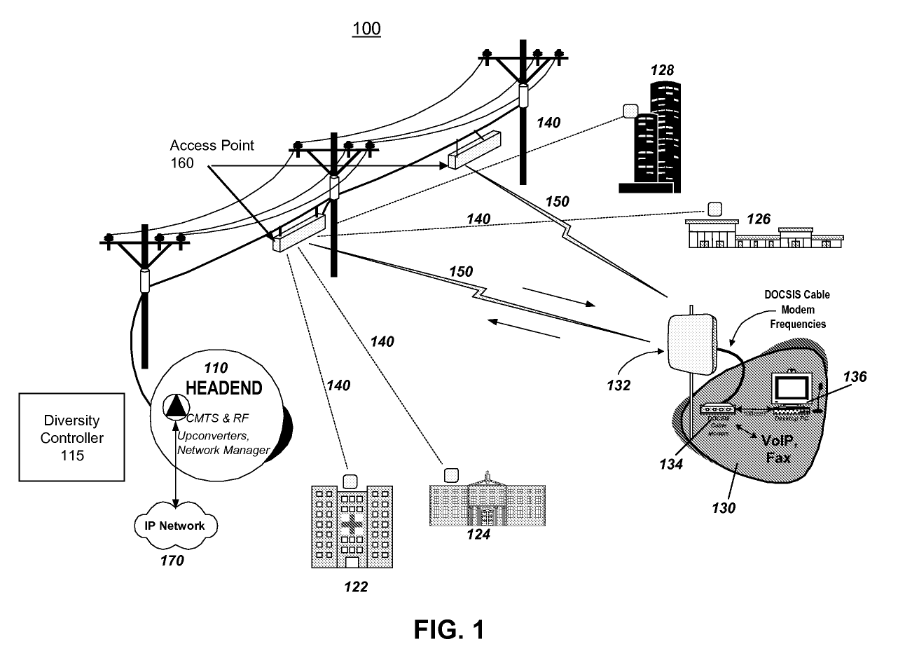

FIG. 1 depicts an exemplary embodiment of a DOCSIS based wireless network 100 for implementing the system and method of the present invention. Network 100 comprises a cable network headend 110, a plurality of subscriber locations 122, 124, 126, 128, and 130, and strand-mounted access point 160. Subscriber locations may connect to access point 160 via wired or wireless communication links. For example, as depicted in FIG. 1, subscriber locations 122-128 are connected to access point 160 via wired communication links 140 and subscriber location 130, may be connected via wireless communication link 150. While access points 160 are depicted at providing both wireless and wired communication, separate access points for wireless and wired communication may be provided.

Cable network headend 110 enables subscriber locations to communicate with external networks, such as external network 170. Headend 110 may include or interface to a cable mode termination system (CMTS), a network management station (NMS), converters, and/or other processing components. A NMS may include one or more servers configured to provide dynamic host configuration protocol (DHCP), time of day (ToD), simple network management program (SNMP), and/or other services needed to allow subscriber locations to communicate with headend 110. The CMTS enables devices located at subscriber locations to exchange digital signals with the network.

Access points 160 may be mounted on existing hardware poles. In accordance with some embodiments, access points 160 enable the cable network to be extended by providing wireless access to the cable headend 100. Access points 160 may be equipped with one or more antennas (not illustrated) for wirelessly transmitting and receiving data to and from one or more subscribing devices (such as subscriber 130) in a designated area. According to an exemplary embodiment, a plurality of access points may be placed at spatially diverse locations such that they are far enough apart to de-correlate multi-path inputs. For example, the access points may be selected such that they are tens of wavelengths apart. Such placement, after processing, may result in an increase in signal-to-noise ratio (SNR) available to the receiver to improve detection performance.

Subscriber location 130 may include an antenna 132 for receiving and transmitting wireless signals to and from access points 160 via wireless communication links 150. Subscriber location 130 also includes customer premise equipment, such as cable modem 134 connected to antenna 132. Cable modem 134 may be configured to convert received data in to a format accessible by user device 136.

According to some embodiments, headend 110 may be configured to perform diversity processing on signals received and transmitted to subscriber locations. As such, headend 110 may include or interface to diversity controller 115. Diversity controller 115 may be integrated into a CMTS, or may be a separate controller device.

Diversity controller 115 may be configured to perform one or more diversity techniques on signals received from the plurality of network antennas located at the cable access points. As described above, the antennas may be spatially separated such that the path to and from each antenna may be different, enabling the antennas to de-correlate multi-path inputs. Diversity controller 115 processes the separately received signals using one or more diversity techniques such as, for example but not limited to, selection diversity, maximal ratio combining, equal gain combining, and/or other spatial combining techniques.

Selection diversity refers to the process of choosing, from among a set of received paths, which path is the cleanest and therefore most likely to be detected successfully. When implementing selection diversity, diversity controller 115 monitors the quality of each incoming signal. This may include, for example, determining the signal-to-noise ratio (SNR) associated with each incoming signal. According to some embodiments, SNR may be measured by the CMTS. In other embodiments, access points may be configured to measure CMTS.

Diversity controller 115 may be configured to select the signal having an optimal SNR. As described above, an administrator may determine which signal is optimal, based on parameters such as cost, performance, and/or other parameters. Diversity controller 115 may continuously monitor the SNR, and if the SNR drops below a predefined threshold, diversity controller 115 may switch to another incoming signal path. For example, diversity controller 115 may switch to the signal path previously calculated to have the next most optimal SNR, or the controller may recalculate the SNR for each signal path, again selecting the path having the optimal SNR. By selecting the best signal path, the likelihood that all of the paths at once are below the predetermined threshold decreases exponentially.

In terms of SNR improvement, the average SNR with diversity selection increases relative to the average SNR of a single channel. More particularly, the average SNR can be shown as follows, with M representing the number of diversity branches available:

Avg SNR (selection diversity)=sum(1/1+1/2+1/3+ . . . 1/M)*Avg SNR (one branch)

A numerical example points out the power of this approach. For M=4, or four diverse branches to select from, and a common Rayleigh fading envelope with an average SNR of 20 dB each, there is roughly a 10% probability that an arbitrary threshold 10 dB lower will be crossed. A 10 dB drop, while arbitrary, represents a significant disruption in terms of supporting modulation profiles and coding gain requirements without adding significant costly single-channel, single receiver, margin to the system. For this same case, but with selection diversity included, the likelihood of the threshold being crossed drops to about 0.01%. This is fully three orders of magnitude of improvement for a very modest number of diverse paths, owing to the exponential relationship.

Maximal ratio combining (MRC) uses the fact that the CMTS is receiving more signal energy than any one path alone offers. In maximal ratio combining, each incoming signal is weighted by a weighting factor in order to optimize the signal noise ratio. Specifically, a weighting factor is chosen based on the SNR of each received signal. After weighting has been applied, the signals are combined and the composite signal may be processed according to typical DOCSIS processing techniques.

Applying maximal rate combining to each signal path results in a favorable increase in SNR. The SNR becomes the sum of the SNR's from each signal path: SNR (MRC)=Σi[SNR(one branch)]i. Most significantly, MRC can produce an acceptable, above threshold, SNR even when no individual SNR is good enough. This means that one network not employing the diversity techniques described herein and exposed to a difficult wireless environment may be unable to support communication and therefore services, while another competing network may perform sufficiently under the same wireless channel conditions.

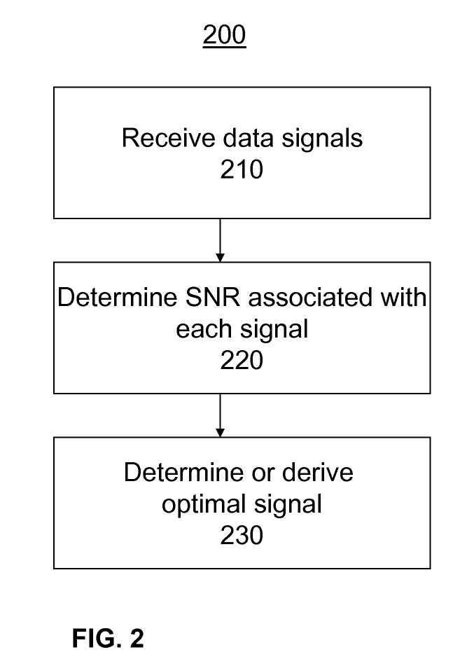

FIG. 2 depicts a method 200 of processing signals in a DOCSIS network at a cable headend, in accordance with one embodiment of the invention. As depicted at 210, the cable headend receives a plurality of data signals. Each signal may be received from one of a plurality of antennas located at separate locations in the network.

According to one embodiment, a CMTS located at the cable headend includes a diversity controller and is configured to process the incoming signals. As depicted at 220, the CMTS processes each of the plurality of signals to determine a signal-to-noise (SNR) ratio associated with the signal. The CMTS then obtains an optimal signal based on the calculated SNR, as depicted at 230. As described above, determining the optimal signal involves performing one or more diversity processing techniques such as selection diversity and maximal ratio combining. Finding this optimal signal improves reception of data, as the controller is able to receive a signal having a signal to noise ratio higher than without processing.

The processes described in connection with FIG. 2 may be implemented in hard wired devices, firmware, or software running in a processor. A processing unit for a software or firmware implementation is preferably contained in the CMTS. Any of these processes may be contained on a computer readable medium which may be read by the CMTS. A computer readable medium may be any medium capable of carrying instructions to be performed by a microprocessor, including a CD disc, DVD disc, magnetic or optical disc, tape, silicon based removable or non-removable memory, packetized or non-packetized wireline or wireless transmission signals.

Those of skill in the art will appreciated that a computer readable medium may carry instructions for a computer to perform a method of processing data signals in a cable data network, the method comprising at least the steps of: receiving a plurality of data signals from a plurality of antennas located at separate locations in the cable data network; determining a signal-to-noise (SNR) ratio associated with each of the received data signals; and obtaining an optimal signal based on the SNR associated with each of the received data signals. The instructions may further include monitoring the SNR associated with each signal to determine if the SNR has changed and switching to another signal if the SNR of the previously selected signals falls below a predefined threshold.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. For example, while the invention has been described herein in terms of a DOCSIS cable network, the system and method may also apply to other cable networks as well. Thus, the present invention is not intended to be limited to the embodiments shown herein, but is to be accorded the full scope consistent with the claims.

What is claimed is:

1. A method of processing data signals in a cable data network, the method comprising the steps of:
receiving a plurality of data signals from a plurality of antennas located at separate locations in the cable data network;
determining a signal-to-noise ratio (SNR) associated with each of the received data signals; and
obtaining an optimal signal to be used by the receiver based on the SNR associated with each of the received data signals.

2. The method of claim 1, wherein obtaining an optimal signal comprises selecting one of the received data signals having the highest SNR.

3. The method of claim 1, wherein obtaining an optimal signal comprises:
selecting a weighting factor to apply to each received signal based on its determined SNR;
applying the selected weighting factor to each received signal; and
combining the weighted signals.

4. The method of claim 3, wherein the weighting factor for each signal is inversely proportional to the signal's SNR.

5. The method of claim 2, further comprising:
monitoring the SNR associated with each signal to determine if the SNR has changed; and
switching to another signal if the SNR of the previously selected signals falls below a predefined threshold.

6. The method of claim 1, wherein the cable data network is a hybrid fiber-coaxial (HFC) network.

7. The method of claim 2, wherein the average SNR of the selected signal increases as the number of signals increases.

8. The method of claim 3, wherein the weighting factors are applied to the signals in parallel.

9. A cable network headend comprising a cable modem termination system (CMTS), the CMTS further comprising:
a diversity controller configured to process signals from a plurality of antennas spatially separated in the cable network and process the plurality of signals to reduce the effects of multipath fading.

10. The cable network headend of claim 9, wherein the diversity controller is configured to:
determine a signal-to-noise ratio (SNR) associated with each of the received data signals; and
obtain an optimal signal based on the SNR associated with each of the received data signals.

11. The cable network headend of claim 9, wherein the diversity controller is configured to obtain an optimal signal by:
selecting a weighting factor to apply to each received signal based on its determined SNR;
applying the selected weighting factor to each received signal; and
combining the weighted signals.

12. The cable network headend of claim 9, wherein the diversity controller is configured to obtain an optimal signal by selecting one of the received data signals having the highest SNR.

13. A computer readable medium carrying instructions for a computer to perform a method of processing data signals in a cable data network, the method comprising the steps of:
receiving a plurality of data signals from a plurality of antennas located at separate locations in the cable data network;
determining a signal-to-noise ratio (SNR) associated with each of the received data signals; and
obtaining an optimal signal based on the SNR associated with each of the received data signals.

14. The computer readable medium according to claim 13, wherein obtaining an optimal signal comprises selecting one of the received data signals having the highest SNR.

15. The computer readable medium according to claim 13, wherein obtaining an optimal signal comprises:
selecting a weighting factor to apply to each received signal based on its determined SNR;
applying the selected weighting factor to each received signal; and
combining the weighted signals.

16. The computer readable medium of claim 15, wherein the weighting factor for each signal is inversely proportional to the signal's SNR.

17. The computer readable medium of claim 14, wherein the method further comprises:
monitoring the SNR associated with each signal to determine if the SNR has changed; and
switching to another signal if the SNR of the previously selected signals falls below a predefined threshold.

18. The computer readable medium of claim 13, wherein the cable data network is a hybrid fiber-coaxial (HFC) network.

19. The computer readable medium of claim 14, wherein the average SNR of the selected signal increases as the number of signals increases.

20. The computer readable medium of claim 15, wherein the weighting factors are applied to the signals in parallel.
